(19) United States
(12) Patent Application Publication
(10) Pub. No.: US 2016/0103839 A1
(43) Pub. Date: Apr. 14, 2016

(54) FOOD RECIPE SCORING AND RANKING SYSTEM

(71) Applicant: International Business Machines Corporation, Armonk, NY (US)

(72) Inventors: Faheem Altaf, Pflugerville, TX (US); Florian Pinel, New York, NY (US); Nan Shao, Ridgefield, CT (US)

(21) Appl. No.: 14/859,440

(22) Filed: Sep. 21, 2015

Related U.S. Application Data
(63) Continuation of application No. 14/513,592, filed on Oct. 14, 2014.

(51) Int. Cl. G06F 17/30; G06F 3/0482

(52) U.S. Cl. CPC G06F 17/3053; G06F 3/0482

(57) ABSTRACT

According to an aspect, food recipes are scored and ranked based on one or more culinary objectives. A general dish specification includes a selected dish type, a selected cuisine type, and one or more culinary objectives. Candidate ingredient types are identified based on recipes of the selected dish type and the selected cuisine type in a recipe database. A number or range of ingredients are computed for each candidate ingredient type based on a frequency of occurrence of ingredients of each candidate ingredient type. A recipe closeness score is computed for a plurality of the recipes of the selected dish type and the selected cuisine type in the recipe database based on the culinary objectives, a bill of ingredients, and parameters for the recipes stored in the database. The recipes are ranked based on the recipe closeness scores and a ranked list of the recipes is provided.

### DOMESTIC PRIORITY

This application is a continuation of U.S. patent application Ser. No. 14/513,592, filed Oct. 14, 2014, the content of which is incorporated by reference herein in its entirety.

### BACKGROUND

The present disclosure relates generally to food preparation systems, and more specifically to a food recipe analysis system that scores and ranks recipes based on one or more culinary objectives.

Many people attempt to follow dietary restrictions for a variety of reasons, such as weight loss, high blood pressure, and food allergies. People also have taste preferences, which can vary from time to time. A wide range of recipe books and databases are available, including those containing recipes for certain dietary restrictions, such as low fat, low calorie, gluten free, and lactose free meals. There are no resources available, however, that match recipes to other culinary objectives, such as taste preferences, and combinations of objectives, such as dietary restrictions and taste preferences. Food preparers may therefore find themselves uncertain in how to proceed when preparing meals to meet a variety of culinary objectives.

### SUMMARY

Embodiments include a method, system, and computer program product that scores and ranks food preparation recipes based on one or more culinary objectives. A method includes receiving a general dish specification that includes a selected dish type, a selected cuisine type, and one or more culinary objectives. Candidate ingredient types are identified based on recipes of the selected dish type and the selected cuisine type in a recipe database. A number or range of ingredients are computed for each candidate ingredient type based on a frequency of occurrence of ingredients of each candidate ingredient type in the recipes of the selected dish type and the selected cuisine type in the recipe database. A bill of ingredients selection menu is provided including the candidate ingredient types and prompts to select the computed number or range of ingredients for each candidate ingredient type. A bill of ingredients is received including ingredient selections for each candidate ingredient type corresponding to the prompts of the bill of ingredients selection menu. A recipe closeness score is computed for a plurality of the recipes of the selected dish type and the selected cuisine type in the recipe database based on the culinary objectives, the bill of ingredients, and parameters for the recipes stored in the database. The recipes are ranked based on the recipe closeness scores and a ranked list of the recipes is provided.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a food recipe analysis system in accordance with an embodiment;

FIG. 2 depicts a user interface for receiving a general dish specification in accordance with an embodiment;

FIG. 3 depicts a user interface for specifying a bill of ingredients in accordance with an embodiment;

FIG. 4 depicts an ingredient frequency distribution table in accordance with an embodiment;

FIG. 5 depicts a user interface for displaying a ranked list of recipes and receiving recipe refinements in accordance with an embodiment;

FIG. 6 depicts a logic structure diagram for the food recipe analysis system accordance with an embodiment; and

FIG. 7 depicts a processing system suitable for implementing the food recipe analysis system in accordance with an embodiment.

### DETAILED DESCRIPTION

Embodiments described herein relate to a food recipe analysis system that scores and ranks recipes based on one or more culinary objectives, such as dietary constraints and taste preferences. In an illustrative embodiment, a user inputs a general dish specification by selecting a dish type and cuisine type via a user interface menu. The user also specifies one or more culinary objectives for the dish, such as a dietary constraint and a flavor preference profile. The system generates a bill of ingredients selection menu based on an ingredient frequency distribution analysis of recipes of the selected dish type and cuisine type in a recipe database. The user then narrows the bill of ingredients by selecting items on the bill of ingredients selection menu. The system scores the recipes based on closeness to the specified objectives and returns a ranked list of recipes indicating or reflecting the computed scores for the selected culinary objectives. Illustrative culinary objective scores include a dietary constraint score and a flavor preference score. The system may also allow the user to refine the list of recipes by including or excluding ingredients and refreshing the list.

Commonly owned U.S. patent application Ser. No. 13/347,099 entitled “Automatic Generation of New Work Products and Work Plans” filed Mar. 19, 2013, is incorporated herein by reference in its entirety. U.S. patent application Ser. No. 13/847,099 describes a method to generate recipes in the form of ingredient combinations without specifying specific proportions of the ingredients.

Technical effects and benefits of embodiments described herein include the ability to score and rank recipes based on their correspondence to one or more culinary objectives. The rank may reflect a combination of the scores, while the individual scores reveal the degree of correspondence between the recipes and the selected criteria. This allows a user to quickly find suitable recipes in a ranked order with informational scores assigned to the recipes corresponding to the culinary objectives selected by the user. The user can easily refine the recipe list by changing ingredients and obtain additional ranked lists of recipes by changing the dish type, cuisine type, dietary restriction, bill of ingredients, or the flavor preference profile. Providing the user with a range of suitable recipe choices along with informational scores helps the user make well informed eating decisions and improves compliance with dietary plans.

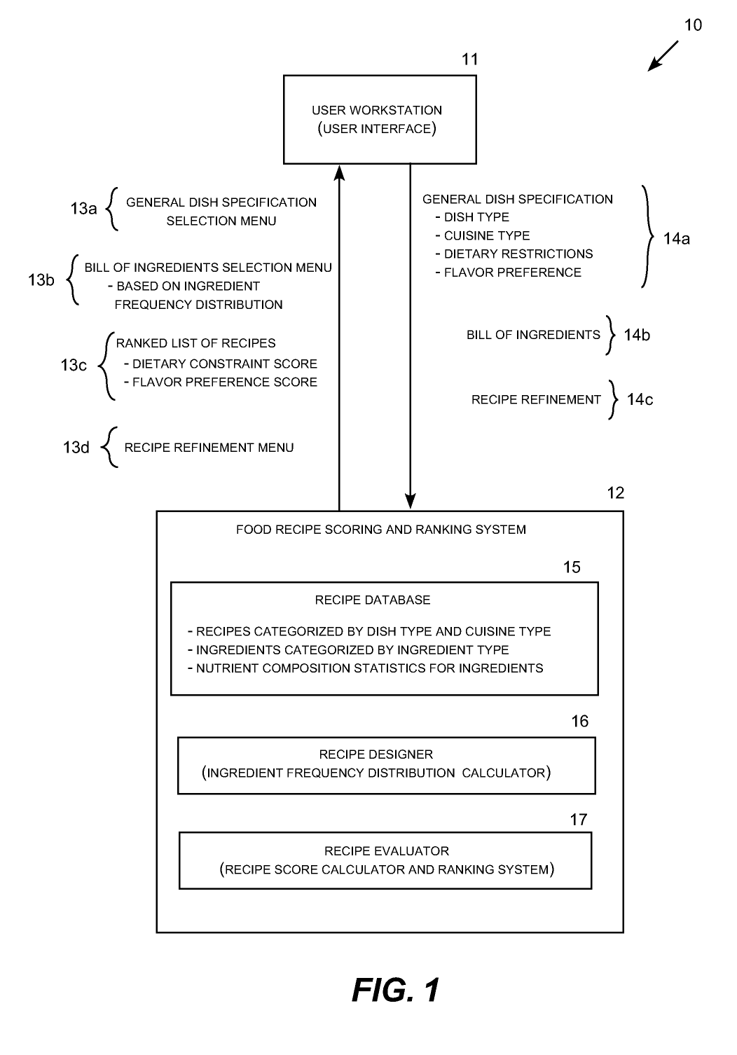

Turning now to FIG. 1, a food recipe analysis system 10 includes a user workstation 11 that displays a user interface for interacting with a food recipe scoring and ranking system 12. The functionality of the embodiment is largely indifferent to the type of computer or network architecture used to implement the functionality. In one particular embodiment, the user workstation 11 may be a desktop or laptop computer utilizing a browser to access the food recipe scoring and ranking system 12 running on a server over a network, such as the Internet. In another embodiment, the user workstation 11 may be a smartphone utilizing an application to access the food recipe scoring and ranking system 12 over a WiFi or other suitable network connection. As another example, the food recipe scoring and ranking system 12 may include an application program running on a laptop or desktop computer or a server connected to the user workstation over an Ethernet or other type of computer network. It will be appreciated that any other computer environment allowing a user to interact with an automated food preparation proportion balancing system may be used to realize embodiments of the invention.

The food recipe scoring and ranking system 12 includes a recipe database 15 that can include a large number of recipes that each identify a dish type (e.g., pasta dish, egg dish, pizza dish, grilled meat dish, fish dish, etc.) and a cuisine type (e.g., Italian, Tex-Mex, Chinese, etc.). Each recipe includes a number of ingredients that each correspond to one or more ingredient types (e.g., meat, vegetable, sauce, grain, spice, etc.). Each ingredient can further identify a nutrient composition typically by percent weight (e.g., A % water, B % carbohydrate, C % protein, and Z % fat). Other nutrients may be specified as desired (e.g., salt, sugar, spice, gluten, lactose, vitamins, fiber, etc.). The recipe database may be updated continually by adding or deleting recipes, ingredients, and nutrient components.

The food recipe scoring and ranking system 12 also includes a recipe designer 16 that interacts with a user, typically through a system of interactive user interface menus to define a partial dish specification. The user specifies a dish type and a cuisine type recipe, and the designer 16 utilizes an ingredient frequency distribution calculator to prompt the user to select a number of ingredients in a number of ingredient type categories based on a statistical analysis of recipes in the database having the same dish type and cuisine type. Generally described, the interactive user interface can prompt the user to complete a bill of ingredients and specify additional dish objectives, such as a dietary constraint and a flavor preference profile. A recipe evaluator 17 scores corresponding recipes based on how closely they satisfy the dish objectives, ranks the corresponding recipes based on a weighted combination of the dish objective scores, and displays a ranked list of recipes to the user. The interactive user interface allows the user to refine and refresh the ranked recipe list.

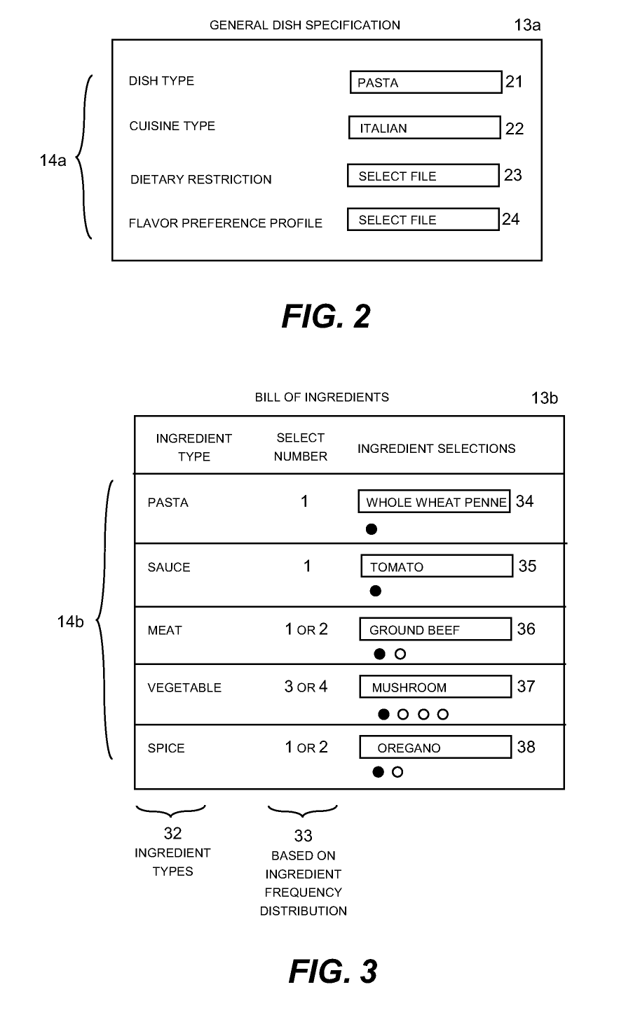

More specifically in one particular example, the food recipe scoring and ranking system 12 can cause the user workstation 11 to display a general dish specification selection menu 13a. The user completes and submits the selection menu 13a with selections 14a defining a general dish specification, which in this example includes a dish type, cuisine type, dietary restriction, and flavor preference. FIG. 2 depicts an example user interface for receiving the general dish specification that includes a dish type selection item 21, a cuisine type selection item 22, a dietary restriction selection item 23, and a flavor preference selection item 24. The dish type selection item 21 may utilize a pop-up menu in which the user selects among dish types refined in the recipe database 15. Similarly, the cuisine type selection item 22 may utilize a pop-up menu in which the user selects among cuisine types refined in the recipe database 15.

The dietary constraint selection item 23 allows the user to select a particular dietary restriction among a number of files or entries containing dietary restrictions, such a number of user-defined dietary restriction files and a number of predefined dietary restriction files or entries. Example dietary restrictions include files defining daily nutrient allowances (e.g., X gm of carbohydrate, Y gm of protein, and Z gm of fat). Daily nutrient allowances specified for weight loss objectives, bodybuilding objectives, health curative and preventative objectives defined by third parties may be included among the selection items. As additional options, a continually updated database of predefined nutrient allowance profiles may be accessed through the dietary constraint selection item 23, and a “wizard” selection may activate an application allowing the user to create a new dietary restriction file.

The dietary constraint selection item 23 may also specify other types of dietary restriction entries, such as low calorie, low salt, low fat, lactose free, gluten free, and so forth. Any number of dietary restrictions may be selected, although the number of corresponding recipes can be expected to diminish as the number of restrictions increases. In general, a dietary constraint selection item may be included for any recipe component that is numerically represented in recipes in the database 15. For example, if “calorie content” is included as a parameter in the recipes in the database, a dietary constraint selection item may be included for “calorie content.” Similarly, if “spice level” (e.g., capsaicin) is included as a parameter in the recipes in the database, a dietary constraint selection item may be included for “spice level”. If “salt level” is included as a parameter in the recipes in the database, a dietary constraint selection item may be included for “salt level”. As another example, if “gluten content” is included as a parameter in the recipes in the database, a dietary constraint selection item may be included for “gluten content.” It will therefore be appreciated that a dietary constraint selection item may be provided for any food component that that is numerically expressed for at least a subset of the various recipes in the database 15. A new dietary restriction selection option may therefore be added by adding a corresponding numerical value for the dietary constraint in at least a subset of the various recipes in the database 15. Additional illustrative (but by no means exhaustive) list of food components that may be represented as dietary restriction selection options include, sugar content, vitamin content, collagen content, fiber content, food allergen content (e.g., peanut, lactose, etc.), antioxidant content, and so forth.

The flavor preference item 24 also allows the user to select a particular flavor preference profile among a number of files or other flavor preference entries. For example, the user may select among a number of saved flavor preference profiles, and among a number of predefined taste preferences, such as “spicy hot” or “mild cheese.” The flavor preference profile may include a standard set of taste parameters. For example, each ingredient may be assigned a taste parameter for each of the five tastes (sweet, salty, sour, bitter, umami) recorded in the recipe database 15. As with the dietary constraint selection item, a flavor preference selection item may be included for any flavor indicator that is numerically represented in recipes in the database 15. A taste preference “wizard” may allow a user to create, name and save a number of taste profiles by selecting preferred foods through an interactive menu system. The taste preference wizard may also allow the user to create taste preference profiles by rating recipes they have tried and assigning them to saved profiles. For example, a user may give a “spicy hot” rating on a scale of 1 to 5 to a particular dish, which is recorded as part of a “sweet hot” taste profile saved for the user. As another example, a user may give a “mild cheese” rating on a scale of 1 to 5 to a particular dish, which is recorded as part of a “mild cheese” taste profile saved for the user. Additional taste profiles may be created and saved by the user through ongoing use of the system.

Referring again to FIG. 1, the food recipe and scoring system 12 responds to a general dish specification in the selections 14a with a bill of ingredients selection menu 13b, which allows the user to narrow the bill of ingredients. FIG. 3 depicts an example bill of ingredients selection menu 13b. The user completes the bill of ingredients selection menu to define a bill of ingredients 14b. The bill of ingredients selection menu 13b includes a list of ingredient types 32 and a list of “select numbers” indicators 33 prompting the user to select a number of ingredients for each ingredient type. The selection items 34-38 allow the user to make selections for the indicated number of ingredients in each ingredient type category. The ingredient types reflect the ingredient types in the recipes in the database 15 corresponding to the dish type and the cuisine type selected as part of the general dish specification. In this particular example, the selected dish type is “pasta” and the selected cuisine type is “Italian” as shown in FIG. 2. All of the corresponding ingredient types may be shown, or only those occurring above a particular frequency (e.g., only those occurring in 20% or more of the corresponding recipes) as a matter of design type. As an option, the user may be provided with a user interface option for selecting this parameter. The ingredient types are typically sorted and displayed in descending order of frequency in the corresponding recipes. As an option, the user may be provided with a user interface item for selecting the sort order and parameter, which may be any parameter numerically reflected in the database (e.g., sort in descending order of protein content, ascending order of salt content, etc.)

In the particular example shown in FIG. 2, the user specified “pasta” as the dish type and “Italian” as the cuisine type. In FIG. 3, the selection item 32 prompts the user to select one pasta type (“whole wheat penne” is selected), the selection item 33 prompts the user to select one sauce type (“tomato” is selected), the selection item 34 prompts the user to select one or two meat types (“ground beef” is selected), the selection item 35 prompts the user to select three or four vegetable types (“mushroom” is selected), and the selection item 36 prompts the user to select one or two spice types (“oregano” is selected). The ingredient types are listed in descending order of frequency of occurrence in the corresponding recipes (i.e., recipes of “pasta” dish type and “Italian” cuisine type) in the recipe database. The ingredient choices in each ingredient type category are typically presented in a ranked order based on their frequency of occurrence in the corresponding recipes in the recipe database and/or an ingredient preference score indicated by the selected flavor preference. Radio buttons indicate selections that have been specified and those remaining.

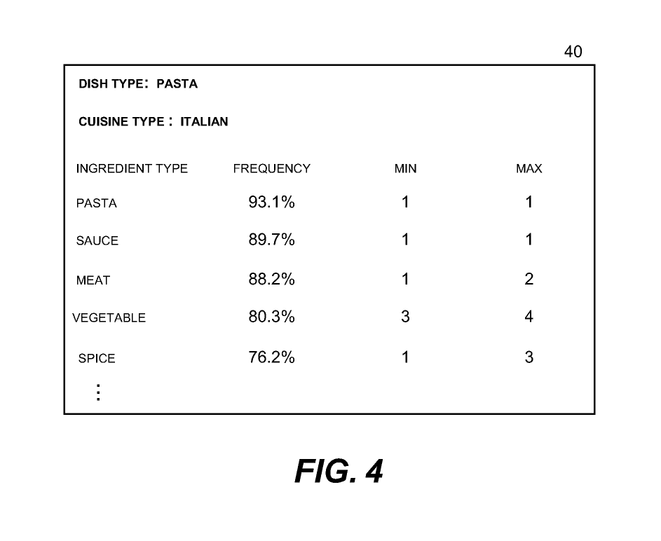

The “select number” is based on the frequency of occurrence of the number of ingredients in the recipes of the corresponding recipes. FIG. 4 depicts an ingredient frequency distribution table 40 to illustrate this feature. The frequency of occurrence of the ingredient types in the corresponding recipes is shown. The “min” and “max” indicate a range for the number of ingredients within each ingredient type category. The range is typically based on a selected statistical parameter, such as one or two standard deviations about the average. As an option, the user may be provided with a user interface item for selecting this parameter. In this particular example, the corresponding recipes (i.e., recipes of “pasta” dish type and “Italian” cuisine type) include one pasta type ingredient within one standard deviation of the average; the corresponding recipes include one sauce type ingredient within one standard deviation of the average; the corresponding recipes include one meat type ingredient within one standard deviation below the average and two meat type ingredients within one standard deviation above the average; the corresponding recipes include three vegetable type ingredients within one standard deviation below the average and four vegetable type ingredients within one standard deviation above the average; and the corresponding recipes include one spice type ingredient within one standard deviation below the average and three spice type ingredients within one standard deviation above the average. The bill of ingredients selection menu 13b user interface shown in FIG. 3 therefore uses these “min” and “max” statistics in the “select number” fields for ingredient selection to complete the bill of ingredients 14b.

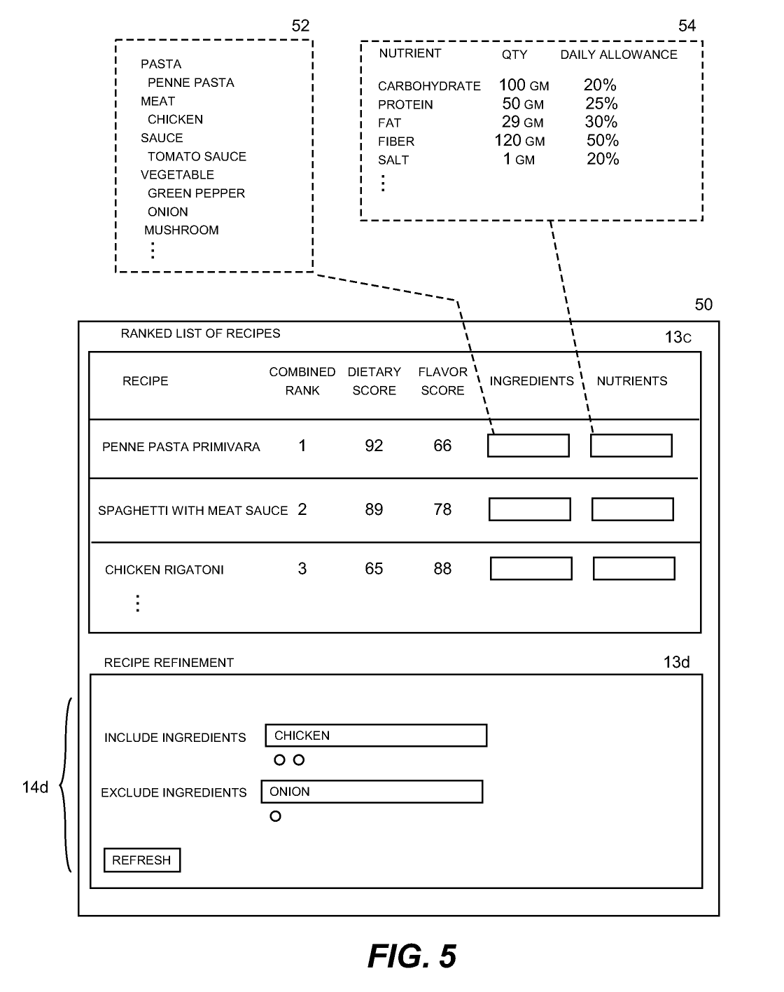

Referring to FIG. 5, the food recipe and scoring system 12 responds to the bill of ingredients 14b with a recipe scoring and ranking user interface menu 50, which displays a ranked list of recipes 13c and a recipe refinement menu 13d that allows the user to refine the bill of ingredients by adding or excluding specific ingredients. Each recipe includes a score for each dietary objective specified in the general dish specification selection menu 13a shown in FIG. 2. In this particular example, each recipe has a dietary score corresponding to the dietary objective specified in the general dish specification selection menu 13a, and has a flavor score corresponding to the flavor preference specified in the general dish specification selection menu 13a. In this particular example, the dietary score and the flavor score are shown as a distance measure of each recipe from the respective dietary objective on a normalized scale of 100. Alternatively, the relative ordinal rank or another suitable measure may be utilized. A user interface item may also allow the user to select among a number of available scoring measures. Each recipe also receives a combined rank, which is computed as a weighted average of the dietary objective scores for the recipe. The order in which the recipes are disclosed may reflect the combined rank without explicitly displaying the computed ranking parameter. As another option, a user interface item may allow the user to select the relative weight applied to each dietary score in the computation of the combined rank.

The ranked list of recipes menu 50 also displays the ingredients menu 52 and displays or allows the user to select the complete recipe. The menu 50 also includes the nutrients menu 54 for each recipe. Each recipe parameter numerically reflected in the recipes in the database may be displayed. The nutrients may also be displayed in a variety of units, such as absolute quantity, percent of dish by weight, percent of daily allowance according to the dietary constraint, and so forth. A range of features may be provided, for example allowing the user to add, delete or substitute ingredients in the menu 52 and view the corresponding nutrient breakdown in a refreshed menu 54.

Another option is shown in the recipe refinement menu 13d, which allows the user to refine the ranked list of recipes by including or excluding specific ingredients. The user completes the menu 13d with entries 14d to specify a recipe refinement and selects the “refresh” button, and the system return a refreshed ranked list of recipes in the display panel 13d. In this particular example, the user has specified a recipe refinement to limit the list of recipes to dishes that include “chicken” and exclude “onion.” Radio buttons indicate the number of ingredient inclusions and exclusions that have been specified. This allows the user to quickly identify and review the scores for recipes that meet a narrower definition of ingredients.

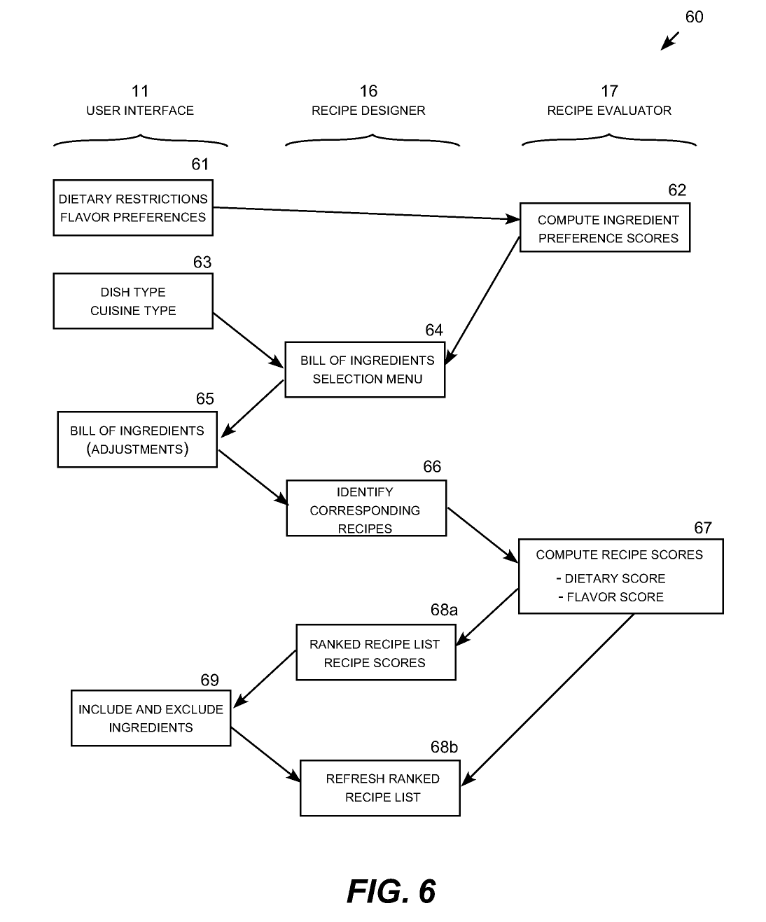

FIG. 6 depicts an example of a logic structure diagram 60 for the food recipe analysis system 10 shown in FIG. 1. In block 61, the user interface on the user workstation 11 receives one or more dietary restrictions and one or more flavor preferences, for example through the user selections 14a entered into the selection menu 13a shown in FIG. 2. In block 62, the recipe evaluator 17 assigns ingredient preference scores to the ingredients in the recipe database 15 to reflect the dietary restrictions and flavor preferences. In block 63, the user interface on the user workstation 11 receives a dish type selection and a cuisine type selection, for example through the user selections 14a entered into the selection menu 13a shown in FIG. 2.

In block 64, the recipe designer 16 uses the selected dish type and cuisine type along with the ingredient preference scores to generate a bill of ingredients selection menu. The dish type and cuisine type selections eliminate certain ingredients from the bill of ingredients selection menu. For example, only those ingredients represented in the recipes in the database 15 corresponding to the selected dish type and cuisine type may be included in the bill of ingredients selection menu. The ingredient preference scores are typically used to rank the ingredient choices displayed in the bill of ingredients selection menu. For example, the order of ingredients shown in the pop-up menu for the ingredient type in FIG. 1 may be based on the ingredient preference score assigned by the recipe evaluator 17, which are based on the dietary restrictions and flavor preferences selected by the user in block 61. In this particular example, “whole wheat penne pasta” is the past choice assigned the highest ingredient preference score assigned by the recipe evaluator 17. The frequency of occurrence of the ingredients for the corresponding recipes in the recipe database may also be used to order the ingredient choices. As another option, a user interface item may allow the user to select the ranking parameter for ingredients presented for selection within the ingredient type categories.

In block 65, the user interface on the user workstation 11 receives ingredient selections further specifying the bill of ingredients. In block 65, the recipe designer 16 identifies all of the recipes in the database 15 that correspond to the bill of ingredients. This may include generating all of the possible ingredient combinations consistent with the bill of ingredients and identifying the corresponding recipes. The recipe designer 16 may identify recipes that have exact matches for all ingredient types as well as recipes that are not exact matches in order to provide at least a preset number of recipe choices. As another option, a user interface item may allow the user to select the minimum number of recipes to include in the ranked recipe list. The closeness measure for the process may reflect the recipes that match the largest number of ingredients types in the frequency distribution order for the specified dish type and cuisine type. In this particular example, the ingredient type frequency distribution table 40 shown in FIG. 4 may be utilized to match recipes to the bill of ingredients.

In block 67, the recipe evaluator 17 computes the dietary objective scores for the corresponding recipes identified by the recipe designer 16. In block 68a, the recipe designer 16 computes a combined rank for each recipe based on a weighted sum of the respective dietary objective scores and orders the recipes based on the combined ranking. In block 69, the user interface on the user workstation 11 receives recipe refinement through including and exclusion of ingredients. In block 68b, the recipe designer 16 refreshes the ranked list of recipes, which may include identifying additional recipes corresponding to the refined bill of ingredients and obtaining additional dietary objective scores from the recipe evaluator 17.

In this particular example, the recipe evaluator 17 computes the dietary score, the flavor score, and a combined rank based on a weighted sum of these dietary objective scores. It will be appreciated that other dietary objectives may be scored and included in the ranking. To provide another illustrative example, a pairing score may be computed based on the frequency of occurrence of ingredient combinations in the corresponding recipes in the database. For example, beef may occur more frequently in combination with tomato sauce, while chicken may occur more frequently in combination with Alfredo sauce, and veal may occur more frequently in combination with wine sauce. The combinations that occur more frequently receive higher pairing scores, which are included in the combined ranking computation.

A range of statistical techniques may be utilized to compute the dietary objective. For a nutrient-based dietary objective, a ratio of the nutrient value for each ingredient to the nutrient value for the dietary constraint may be computed for each ingredient. This results in a nutrient vector of ratios for each ingredient, with each element corresponding to one nutrient. A set of nutrient vectors can be computed for each recipe. The nutrient score may then be based on the statistical distance of the set of nutrient vectors for each recipe to a target value.

For example, the target value for a particular nutrient could be 30% for breakfast, 30% for lunch, and 40% for dinner. For the fat nutrient, this target value means that the user has targeted 30% of the daily allowance of fat from breakfast, 30% of the daily allowance of fat from lunch, and 40% of the daily allowance of fat from dinner. The dietary score for a dish can be based on the overall closeness of all nutritional ratios for the dish to the predetermined value for a specified meal, with a closer recipe receiving a higher score. A suitable closeness measure is the inverse of the Euclidian distance between the ratio vector and the vector with predetermined values. If the distance is close to zero, then a very large score is assigned to the ingredient combination list. Those skilled in art of statistical analysis will appreciate that a number of different closeness scores may be defined. As an option, a user interface item may allow the user to select the closeness from a number of stored statistical techniques.

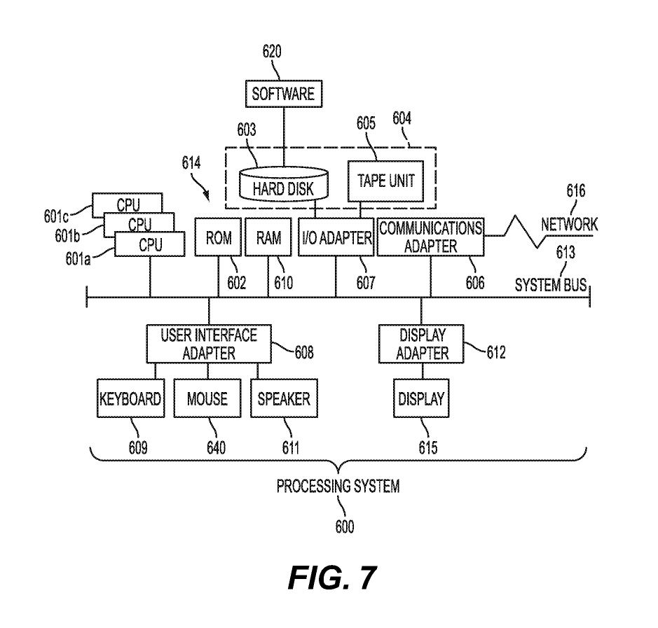

Referring now to FIG. 7, there is shown an embodiment of a processing system 600 for implementing the teachings herein. In this embodiment, the processing system 600 has one or more central processing units (processors) 601a, 601b, 601c, etc. (collectively or generically referred to as processor(s) 601). Processors 601, also referred to as processing circuits, are coupled to system memory 614 and various other components via a system bus 613. Read only memory (ROM) 602 is coupled to system bus 613 and may include a basic input/output system (BIOS), which controls certain basic functions of the processing system 600. The system memory 614 can include ROM 602 and random access memory (RAM) 610, which is read-write memory coupled to system bus 613 for use by processors 601.

FIG. 7 further depicts an input/output (I/O) adapter 607 and a network adapter 606 coupled to the system bus 613. I/O adapter 607 may be a small computer system interface (SCSI) adapter that communicates with a hard disk 603 and/or tape storage drive 605 or any other similar component. I/O adapter 607, hard disk 603, and tape storage drive 605 are collectively referred to herein as mass storage 604. Software 620 for execution on processing system 600 may be stored in mass storage 604. The mass storage 604 is an example of a tangible storage medium readable by the processors 601, where the software 620 is stored as instructions for execution by the processors 601 to perform a method, such as the process flow of FIG. 6. Network adapter 606 interconnects system bus 613 with an outside network 616 enabling processing system 600 to communicate with other such systems. A screen (e.g., a display monitor) 615 is connected to system bus 613 by display adapter 612, which may include a graphics controller to improve the performance of graphics intensive applications and a video controller. In one embodiment, adapters 607, 606, and 612 may be connected to one or more I/O buses that are connected to system bus 613 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 613 via user interface adapter 608 and display adapter 612. A keyboard 609, mouse 640, and speaker 611 can be interconnected to system bus 613 via user interface adapter 608, which may include, for example, a Super I/O chip integrating multiple device adapters into a single integrated circuit.

Thus, as configured in FIG. 7, processing system 600 includes processing capability in the form of processors 601, and, storage capability including system memory 614 and mass storage 604, input means such as keyboard 609 and mouse 640, and output capability including speaker 611 and display 615. In one embodiment, a portion of system memory 614 and mass storage 604 collectively store an operating system such as the AIX® operating system from IBM Corporation to coordinate the functions of the various components shown in FIG. 7.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method for assisting food preparation, the method comprising:
receiving, by the computer, a general dish specification comprising a selected dish type, a selected cuisine type, and one or more culinary objectives;
identifying, by the computer, candidate ingredient types based on recipes of the selected dish type and the selected cuisine type in a recipe database;
computing a number or range of ingredients for each candidate ingredient type based on a frequency of occurrence of ingredients of each candidate ingredient type in the recipes of the selected dish type and the selected cuisine type in the recipe database;
generating a bill of ingredients selection menu including the candidate ingredient types and prompts to select the computed number or range of ingredients for each candidate ingredient type;
receiving, by the computer, a bill of ingredients including ingredient selections for each candidate ingredient type corresponding to the prompts of the bill of ingredients selection menu;
computing a recipe closeness score for a plurality of the recipes of the selected dish type the selected cuisine type in the recipe database based on the bill of ingredients, the culinary objectives and parameters for the recipes stored in the database;
ranking the recipes based on the recipe closeness scores; and
providing, by the computer, a ranked list of the recipes.

2. The method of claim 1, further comprising:
computing an ingredient closeness score for a plurality of ingredients based on a correspondence between the culinary objective and one or more parameters for each ingredient stored in the recipe database; and
providing ingredients associated with each ingredient type in a ranked order based on the computed ingredient scores.

3. The method of claim 1, wherein the culinary objective comprises a taste preference profile including a set of taste components including one or more of sweet, salty, sour, bitter, and umami.

4. The method of claim 1, wherein the culinary objective comprises a nutrient profile including a set of nutrient components including one or more of carbohydrate, protein, fat, fiber, salt, spice, calorie, gluten, and lactose.

5. The method of claim 1, further comprising:
receiving multiple culinary objectives;
computing a recipe closeness score for each culinary objective for a plurality of recipes of the selected dish type and the selected cuisine type in the recipe database;
computing a combined rank based on a weighted sum of the recipe closeness scores; and
providing the ranked list of recipes based on the combined rank for each recipe and providing the computed recipe closeness score for each culinary objective in association with each recipe in the ranked list.

6. The method of claim 5, wherein:
a first culinary objective comprises a taste preference profile comprising a set of taste components including one or more of sweet, salty, sour, bitter, umami; and
a second culinary objective includes a nutrient profile comprising a set of nutrient components including one or more of protein, fat, fiber, salt, spice, calorie, gluten, and lactose.

7. The method of claim 6, further comprising providing nutrient component values for each recipe in the ranked list of recipes.
